(19) United States
(12) Patent Application Publication
(10) Pub. No.: US 2014/0118386 A1
(43) Pub. Date: May 1, 2014

(54) PROJECTION SYSTEM, PROJECTOR, AND CONTROL METHOD

(71) Applicant: CANON KABUSHIKI KAISHA, Tokyo (JP)

(72) Inventor: Takayuki Hirano, Hiratsuka-shi (JP)

(21) Appl. No.: 14/037,523

(22) Filed: Sep. 26, 2013

(30) Foreign Application Priority Data
Oct. 31, 2012 (JP) 2012-241100

(51) Int. Cl. G09G 3/34

(52) U.S. Cl. CPC G09G 3/3406
USPC 345/589

(57) ABSTRACT

After a luminance reduction process for reducing the luminance of an image in a predetermined region in the image obtained by the obtainment unit, an edge emphasizing process is performed in which an edge of the image that has undergone the luminance reduction process is emphasized, and a luminance limiting process is performed in which the luminance of the image in the predetermined region in the image that has undergone the edge emphasizing process is limited.

### BACKGROUND OF THE INVENTION

1. Field of the Invention

The present invention relates to a projection system, a projector, and a control method.

2. Description of the Related Art

In recent years, the number of pixels in an image that can be utilized by a user increases in accordance with an increase in the number of pixels in image sensors used in digital cameras and the like. In order to project such an image whose pixel number is increased while maintaining high perceived resolution thereof, it is necessary for an image forming sensor of a projection apparatus such as a liquid crystal projector or the like to have a large number of pixels. However, since a projection apparatus including an image forming sensor whose pixel number is increased is expensive, conventionally, a method is sometimes used in which one image is divided, and the divided images are projected as one image using a plurality of projection apparatuses.

Japanese Patent No. 4574819 discloses a technique in which an overlapping region where images overlap is provided in projected images obtained by a plurality of projection apparatuses respectively projecting images, and the luminance in regions of the projected images corresponding to the overlapping region is adjusted to make it difficult for a difference in luminance between the overlapping region and the non-overlapping region to be noticeable.

Meanwhile, in a projection apparatus, when an image (an image to be projected) is projected, various image processes other than luminance adjustment may be performed on the image to be projected. For example, in the case where trapezoidal distortion occurs in a projected image on a screen due to a positional relationship between the screen serving as a projection plane and the projection apparatus, a trapezoid correction process or the like is applied to the image to be projected. In the case where such transformation of the image to be projected is involved, the shape of the region to which luminance adjustment as described in Japanese Patent No. 4574819 is applied and in which the projected images are overlapped also is transformed, as a result of which processes become complicated, and therefore usually, it is preferable that a luminance adjustment process is performed prior to other image processes.

Also, in the case where the image to be projected is transformed, an image interpolation process or the like is involved, and therefore cycle unevenness in luminance, such as so-called moire, may occur. If such luminance unevenness occurs, after a low-pass filtering for reducing luminance unevenness is applied to the image to be projected, an edge emphasizing process for improving the perceived resolution is applied thereto. In the edge emphasizing process, a process in which the luminance value of a high tone pixel is raised (overshot) and the luminance value of a low tone pixel is lowered (undershot) is performed near a detected edge.

However, in the case where the edge emphasizing process is performed after the luminance adjustment process, there have been the following issues. For example, a case is conceivable in which as in FIG. 7, images that each have an edge dividing a low luminance region 706 and a high luminance region 707 in the horizontal direction of the images are projected as one image so that projected images 701 and 702 are arranged in the vertical direction. The luminance of a pixel row defined by A-A′ in non-overlapping regions 704 and 705 where projected images do not overlap is assumed to change between two values with an edge portion being a boundary as shown in FIG. 8A. If the edge emphasizing process is applied at this time, the luminance near the edge is increased on the high luminance side due to overshooting as shown in FIG. 8B. Usually, an upper limit (an upper luminance limit) is set for a luminance value handled in an image processing unit. Thus, with regard to a pixel whose luminance value exceeds the upper luminance limit in overshooting of the edge emphasizing process, the luminance value is replaced by the upper luminance limit.

Meanwhile, in the case where the luminance adjustment is performed such that pixels have luminance values corresponding to one image when a plurality of projected images are overlapped as in Japanese Patent No. 4574819, the luminance values are low before the edge emphasizing process, and therefore replacement of the luminance values due to overshooting does not occur. For example, in a pixel row defined by B-B′ in FIG. 7, that is, in an overlapping region 703 where projected images overlap each other, adjustment is performed on the images to be projected so that the luminance value is reduced as in FIG. 9A, taking the overlap into consideration. If the edge emphasizing process is applied at this time, the luminance near the edge is increased on the high luminance side due to overshooting as shown in FIG. 9B, but since the luminance has been reduced by the luminance adjustment, and the luminance value does not reach the upper luminance limit.

However, in the case where the images that have undergone overshooting in this manner are projected and overlapped, the projected image in the overlapping region has brightness corresponding to the value obtained by adding their luminance values as shown in FIG. 9C. In other words, in the case where one image is projected by a plurality of projection apparatuses, when pixels whose luminance values are overshot are overlapped in the overlapping region of the projected image, the image may become brighter than the brightness corresponding to the upper luminance limit compatible with the image processing unit. That is, there have been a difference in brightness between the overlapping region and the non-overlapping region, and a so-called step created due to processing is noticeable.

### SUMMARY OF THE INVENTION

The present invention was made in view of such problems in the conventional technique. The present invention provides an image processing apparatus, a projection apparatus, a control method, and a program that make it difficult for an overlapping region to be noticeable, when images projected by a plurality of projection apparatuses are overlapped so as to form one image.

The present invention in its first aspect provides a projection system including a first projector and a second projector, the first projector comprising: a first obtainment unit configured to obtain an image to be projected; a first image processing unit configured to process the image obtained by the first obtainment unit; and a first projection unit configured to project the image processed by the first image processing unit on a projection plane, the second projector comprising: a second obtainment unit configured to obtain an image to be projected; a second image processing unit configured to process the image obtained by the second obtainment unit; and a second projection unit configured to project the image processed by the second image processing unit on the projection plane, wherein in a case where the image projected by the first projection unit and the image projected by the second projection unit are superimposed on the projection plane in the projection system, (i) the first image processing unit, after a luminance reduction process for reducing the luminance of an image in a portion to be superimposed of the image obtained by the first obtainment unit, performs an edge emphasizing process for emphasizing an edge of the image that has undergone the luminance reduction process, and performs a luminance limiting process for limiting the luminance of the portion to be superimposed of the image that has undergone the edge emphasizing process; (ii) the second image processing unit, after a luminance reduction process for reducing the luminance of an image in a portion to be superimposed of the image obtained by the second obtainment unit, performs an edge emphasizing process for emphasizing an edge of the image that has undergone the luminance reduction process, and performs a luminance limiting process for limiting the luminance of the portion to be superimposed of the image that has undergone the edge emphasizing process.

The present invention in its second aspect provides a projector comprising: an obtainment unit configured to obtain an image; an image processing unit configured to process the image obtained by the obtainment unit; and a projection unit configured to project the image processed by the image processing unit on a projection plane, wherein the image processing unit, after a luminance reduction process for reducing the luminance of an image in a predetermined region in the image obtained by the obtainment unit, performs an edge emphasizing process for emphasizing an edge of the image that has undergone the luminance reduction process, and performs a luminance limiting process for limiting the luminance of the image in the predetermined region in the image that has undergone the edge emphasizing process.

The present invention in its third aspect provides a control method for a projector, the projector comprising: an obtainment unit configured to obtain an image; an image processing unit configured to process the image obtained by the obtainment unit; and a projection unit configured to project the image processed by the image processing unit on a projection plane, wherein the control method controls the image processing unit so as to perform, after a luminance reduction process for reducing the luminance of an image in a predetermined region in the image obtained by the obtainment unit, an edge emphasizing process for emphasizing an edge of the image that has undergone the luminance reduction process, and a luminance limiting process for limiting the luminance of the image in the predetermined region in the image that has undergone the edge emphasizing process.

Further features of the present invention will become apparent from the following description of exemplary embodiments (with reference to the attached drawings).

### BRIEF DESCRIPTION OF THE DRAWINGS

FIG. 1 is a block diagram showing the functional configuration of a liquid crystal projector 100 according to an embodiment of the present invention.

FIG. 2 is a block diagram showing the internal configuration of an image processing unit 105 according to an embodiment of the present invention.

FIG. 3 is a diagram for describing a luminance adjustment coefficient applied in a luminance adjustment unit 201 according to an embodiment of the present invention.

FIG. 4 is a flowchart showing an example of a projection process executed in a liquid crystal projector 100 according to an embodiment of the present invention.

FIG. 5 is a flowchart showing an example of a luminance value change process executed in the liquid crystal projector 100 according to an embodiment of the present invention.

FIGS. 6A, 6B, and 6C are graphs for describing how a luminance value in an overlapping region is changed in a tone limiting unit 205 according to an embodiment of the present invention.

FIG. 7 is a diagram showing an example of an image to be projected that is to be formed by a plurality of projection apparatuses.

FIGS. 8A and 8B are graphs for describing how a luminance value in a non-overlapping region is changed in the case where an edge emphasizing process is executed.

FIGS. 9A, 9B, and 9C are graphs for describing a step created in an overlapping region in the case where the edge emphasizing process is executed.

### DESCRIPTION OF THE EMBODIMENTS

### Embodiment

Hereinafter, an exemplary embodiment of the present invention will be described in detail with reference to the drawings. Note that an embodiment given below describes an example in which the present invention is applied to a liquid crystal projector as an example of an image processing apparatus, in which an edge emphasizing process can be performed on an image to be projected. However, the present invention can be applied to any equipment that can perform an edge emphasizing process on an image to be projected that has undergone luminance adjustment.

In the present specification, an “image to be projected” refers to an “image” that corresponds to a group of projected images that are to be projected using a plurality of liquid crystal projectors. Also, a description is given hereinafter, where the image projected by each of the liquid crystal projectors is distinguished as a “partial image” of the image to be projected.

Configuration of Liquid Crystal Projector 100

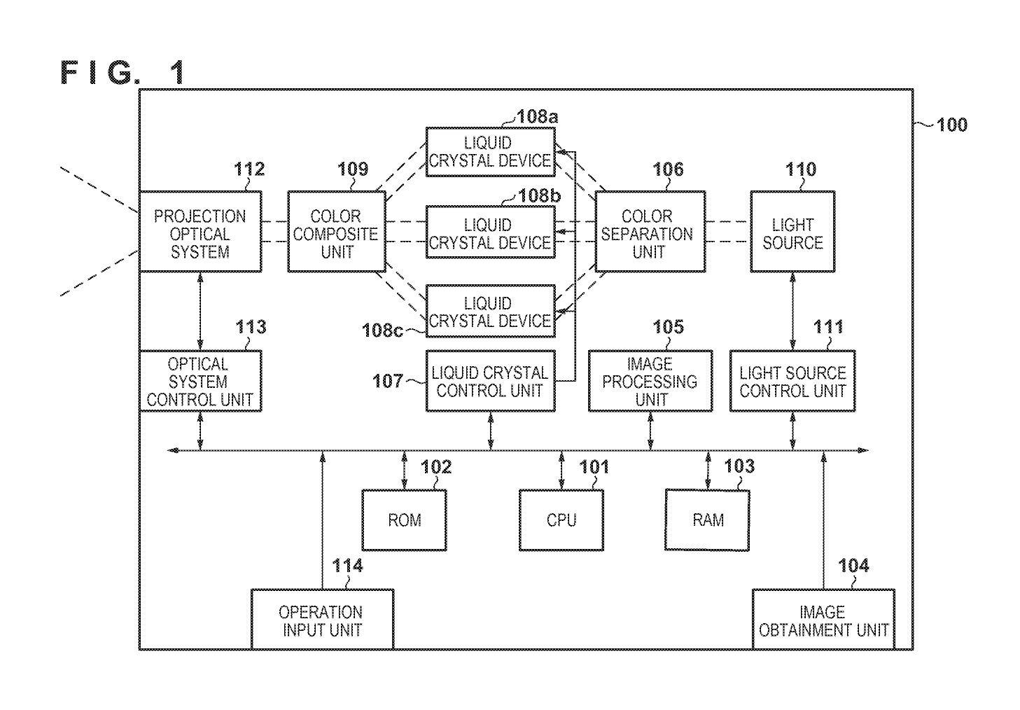

FIG. 1 is a block diagram showing the functional configuration of a liquid crystal projector 100 according to an embodiment of the present invention.

A CPU 101 controls the operations of the blocks included in the liquid crystal projector 100. Specifically, the CPU 101 controls the operations of the blocks by reading out operation programs for the blocks stored in a ROM 102, loading the programs to a RAM 103, and executing them.

The ROM 102 is, for example, a rewritable non-volatile memory. The ROM 102 stores information such as parameters required for the operations of the blocks, in addition to the operation programs for the blocks included in the liquid crystal projector 100. Also, the RAM 103 is a volatile memory. The RAM 103 is used as not only an area for loading the operation programs for the blocks but also a storage area for storing, for example, intermediate data that is output during operations of the blocks.

The image obtainment unit 104 is an input interface of the liquid crystal projector 100 that receives input of an image to be projected. In the present embodiment, the image obtainment unit 104 is provided with a partial image of the image to be projected. The partial image has a region (an overlapping region) where it overlaps a partial image projected by another liquid crystal projector 100. The interface of the image obtainment unit 104 may include, for example, a composite terminal, an S video terminal, a D terminal, a component terminal, an analog RGB terminal, a DVI-I terminal, a DVI-D terminal, an HDMI (registered trademark) terminal and the like. Note that when an analog video signal is input to the image obtainment unit 104, the image obtainment unit 104 coverts the input analog video signal to a digital video signal.

An image processing unit 105 performs various types of image processes on a partial image that is input to the liquid crystal projector 100.

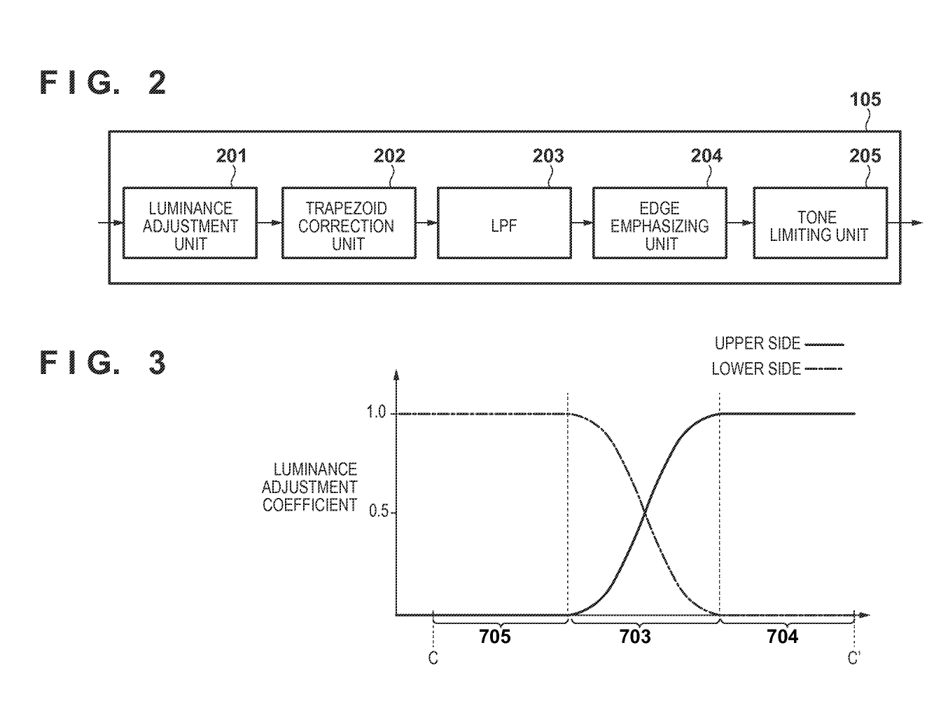

Here, image processes performed in the image processing unit 105 will be described in detail with reference to FIG. 2.

Internal Configuration of Image Processing Unit 105

FIG. 2 shows image processes performed in the image processing unit 105 in the form of blocks. Each block may be provided as a separate hardware circuit, or all or a portion of the blocks may be provided as one hardware circuit. Also, each process may be realized as an image processing program.

If the CPU 101 inputs a partial image to the image processing unit 105, a luminance adjustment process is firstly performed on the input partial image in a luminance adjustment unit 201. To simplify a description, in the present embodiment, it is assumed that the luminance adjustment process performed in the luminance adjustment unit 201 is applied to an overlapping region where its projected image and a projected image of another liquid crystal projector 100 are to be overlapped. In other words, the luminance adjustment process is an image process involving so-called edge blending that makes it difficult that, when its projected image and the projected image of another liquid crystal projector 100 are overlapped, a difference in luminance between the overlapping region and a non-overlapping region where the projected images do not overlap is noticeable.

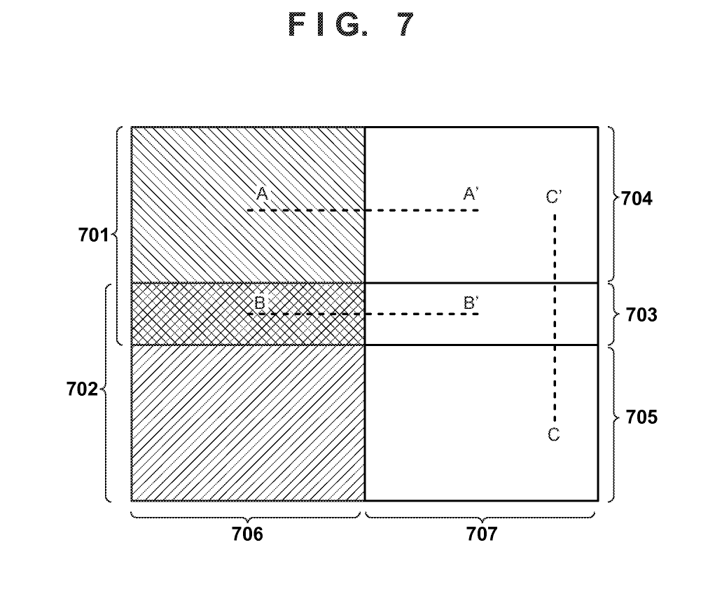

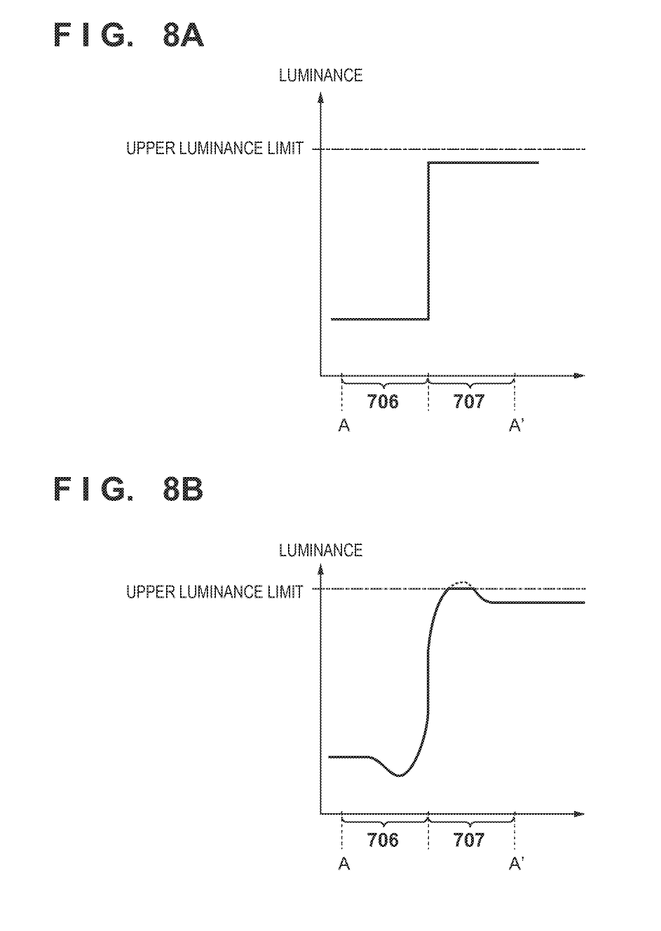

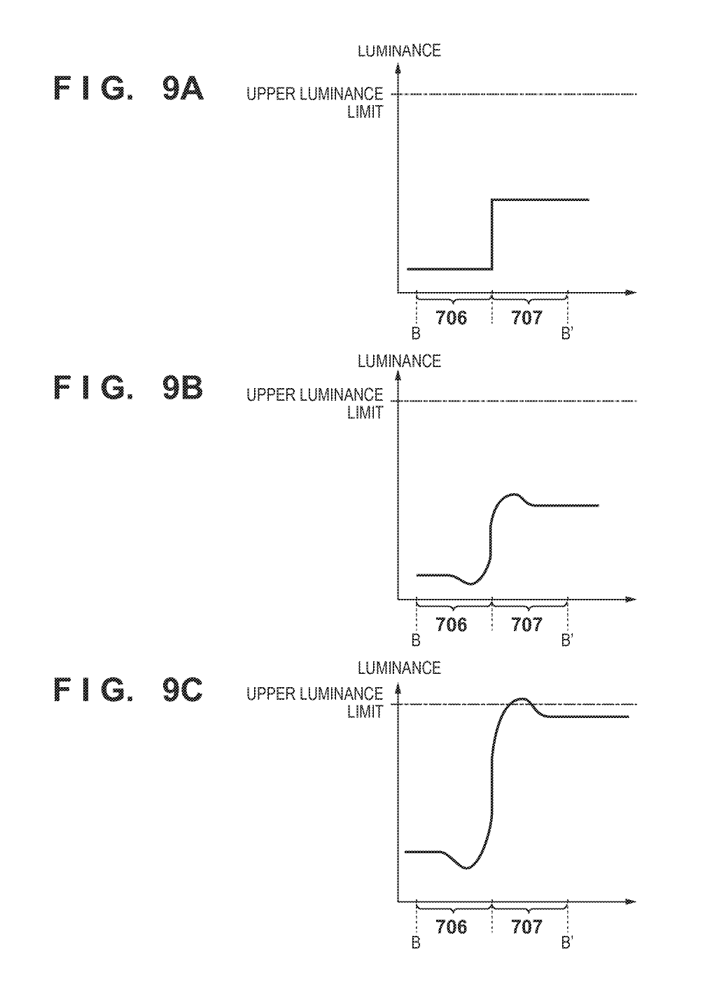

A luminance adjustment coefficient for edge blending may be determined in accordance with, for example, a position in a direction defined by C-C′ in FIG. 7. A description is given, assuming that the luminance adjustment coefficient in the present embodiment is defined by a sigmoid function such that the luminance adjustment coefficient is 0 at one end of the overlapping region that corresponds to the end of each partial image, and it is 1 at the other end of the overlapping region, as shown in FIG. 3. However, a method for defining the luminance adjustment coefficient is not limited to this, and the luminance adjustment coefficient may be any value as long as it is set such that with regard to the partial images where the projected images overlap each other, the total value of luminance adjustment coefficients to be multiplied at the same pixel position of the overlapping region is 1 or a value that can be considered to be 1.

Note that information on the overlapping region may be set in, for example, the liquid crystal projector 100 in advance, or may be included in the input partial image. Also, the information may be information determined by, for example, referring to a state in which the projected images overlap, through communication among a plurality of liquid crystal projectors 100 that project the images to be projected. It is assumed that the luminance adjustment unit 201 refers to the information on the overlapping region and performs the luminance adjustment process on the partial images.

After the luminance adjustment process is performed in the luminance adjustment unit 201, a trapezoid correction process (a keystone correction process) is performed on the partial images in a trapezoid correction unit 202, if necessary. In the case where the projected image on a screen (not shown), which is a projection plane, has a trapezoidal distortion, the trapezoid correction process is performed so that the projected image has a rectangular shape. Whether or not trapezoidal distortion occurs is detected by, for example, an image capturing unit (not shown), and the trapezoid correction unit 202 performs the trapezoid correction process in accordance with the state of distortion.

A low-pass filter (LPF) 203 is a smoothing filter that allows only a low frequency component of an input image to pass through. In the present embodiment, the LPF 203 is used to smooth a high frequency component generated by a pixel interpolation process, which is performed on the partial image when the trapezoid correction process is performed in the trapezoid correction unit 202.

An edge emphasizing unit 204 performs an edge emphasizing process on the partial image smoothed in the LPF 203. The edge emphasizing process first extracts an edge from a luminance image of the partial image, and performs a process in which a high luminance component is overshot and a low luminance component is undershot near the edge.

A tone limiting unit 205 adjusts a luminance value in accordance with a limiting condition, with regard to the partial image that has undergone the edge emphasizing process. Specifically, in the case where the luminance value of a pixel in a region corresponding to a non-overlapping region among the pixels of the partial image exceeds an upper luminance limit due to overshooting performed in the edge emphasizing process, the tone limiting unit 205 changes the pixel value to the upper luminance limit. In the case where the luminance value of a pixel in a region corresponding to an overlapping region among the pixels of the partial image satisfies a specific limiting condition due to overshooting performed in the edge emphasizing process, the luminance value is adjusted. Note that the specific limiting condition will be described in detail along with a projection process described later.

Although a description is given, assuming that the image processing unit 105 of the present embodiment includes blocks performing five image processes in this manner, it can be easily understood that implementation of the present invention is not limited to this. For example, the image processing unit 105 may perform a frame thinning process, a frame interpolation process, a resolution conversion process, or the like, in which the number of frames, the number of pixels, the shape of images, or the like is changed with regard to the input partial image.

The liquid crystal projector 100 of the present embodiment includes three types of liquid crystal devices 108a, 108b, and 108c for an R component, a G component, and a B component that form an image to be projected. With regard to pixels of the liquid crystal devices 108, the amount of light passing through the device is controlled by the liquid crystal control unit 107, based on the pixel value of each component of the image to be projected. Specifically, the liquid crystal control unit 107 adjusts the amount of light to be transmitted by controlling voltage applied to the liquid crystal device associated with each pixel, and forms a projected image corresponding to images projected with light that has passed through the liquid crystal devices 108.

The flux of light entering each liquid crystal device 108 is emitted from a light source 110. The light source 110 may be, for example, a white LED, a halogen lamp, a xenon lamp, a high pressure mercury lamp, or the like, and the amount of light is controlled by a light source control unit 111. The flux of light emitted from the light source 110 is separated into the fluxes of light of RGB components by entering a color separation unit 106 such as a dichroic mirror, a prism, or the like, and reaches the corresponding liquid crystal devices 108. Note that although the light source 110 emits white light in the present embodiment, it goes without saying that the color separation unit 106 is not required in the case where an LED light source corresponding to each color component is provided as the light source 110.

The flux of light passing through the liquid crystal devices 108 enters a color composite unit 109, and reaches a projection optical system 112 in the form of the flux of light that corresponds to an image to be projected and in which the light fluxes of the color components are combined. The color composite unit 109 may be a dichroic mirror or a prism, similarly to the color separation unit 106.

The projection optical system 112 is configured by one or more lenses or the like. The position of a lens is changed by drive control performed by the optical system control unit 113, as a result of which the projection optical system 112 operates so that the fluxes of incident light form an image on a projection plane. Note that control performed by the optical system control unit 113 is not limited to focus adjustment, and it may also performed for zooming in or out the projected image.

An operation input unit 114 is a user interface such as a menu switch, a touch panel, or the like that is included in the liquid crystal projector 100. Upon detecting an operation input made by a user, the operation input unit 114 transmits a control signal corresponding to the operation input to the CPU 101. Note that the operation input unit 114 may detect a wireless signal received from the external apparatus such as a remote controller or the like.

Projection Process

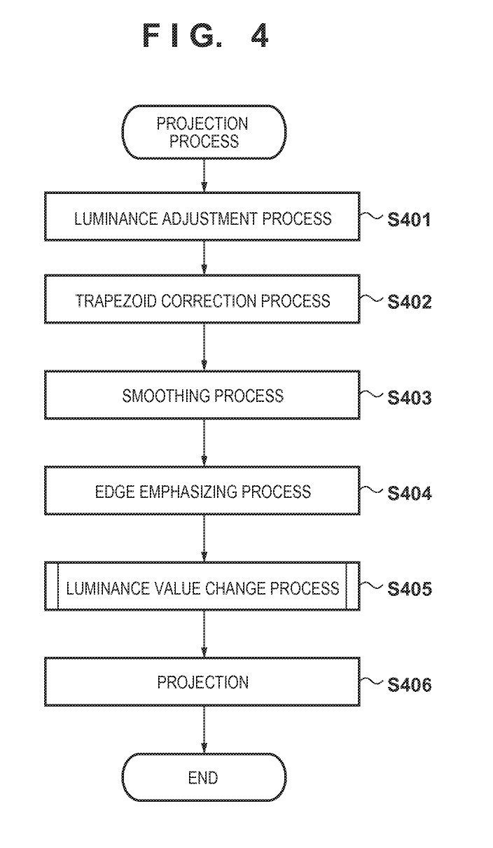

With regard to a projection process performed by the liquid crystal projector 100 of the present embodiment that has such a configuration, a specific process will be described using a flowchart shown in FIG. 4. The process corresponding to the flowchart can be realized by the CPU 101 reading out the corresponding process program stored in the ROM 102, loading the program to the RAM 103, and executing it, for example. Note that a description is given, assuming that this projection process is started when, for example, a partial image corresponding to an image to be projected is input, and is executed every time an image is input.

In step S401, the CPU 101 inputs a partial image to be projected to the image processing unit 105, and causes the luminance adjustment unit 201 to perform a luminance adjustment process on a region corresponding to an overlapping region of the partial image, in accordance with a luminance adjustment coefficient.

In step S402, the CPU 101 causes the trapezoid correction unit 202 to perform a trapezoid correction process on the partial image after the luminance adjustment process is performed.

In step S403, the CPU 101 causes the LPF 203 to perform a smoothing process on the partial image that has undergone the trapezoid correction process.

In step S404, the CPU 101 causes an edge emphasizing unit 204 to perform an edge emphasizing process on the partial image that has undergone the smoothing process.

In step S405, the CPU 101 causes the tone limiting unit 205 to perform a luminance value change process on the partial image that has undergone the edge emphasizing process.

Luminance Value Change Process

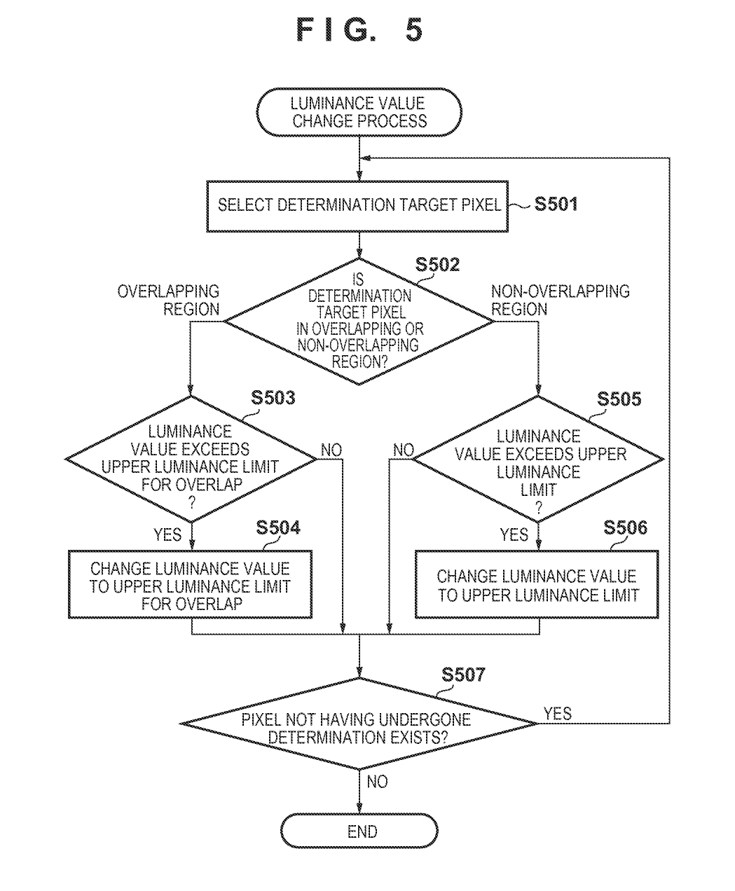

Here, the luminance value change process will be described in detail using a flowchart shown in FIG. 5.

In step S501, the tone limiting unit 205 selects a pixel to be determined (a determination target pixel) among pixels of the partial image that has undergone the edge emphasizing process.

In step S502, the tone limiting unit 205 determines whether the determination target pixel is a pixel in the overlapping region, or a pixel in the non-overlapping region. In the case where it is determined that the determination target pixel is a pixel in the overlapping region, the tone limiting unit 205 moves the processing to step S503, and in the case where it is determined that the determination target pixel is a pixel in the non-overlapping region, it moves the processing to step S505.

In step S503, the tone limiting unit 205 determines whether or not the luminance value of the determination target pixel exceeds a value (an upper luminance limit for the overlap) obtained by multiplying a luminance adjustment coefficient applied to the pixel by an upper luminance limit. Although the maximum luminance value that can be handled in the image processing unit 105 is used as an upper luminance limit in the present embodiment, implementation of the present invention is not limited to this. A value set as the upper luminance limit may be a value set for the projected image, or may be a value lower than the maximum luminance value in the processing. In the case where it is determined that the luminance value of the determination target pixel exceeds the upper luminance limit for the overlap, the tone limiting unit 205 moves the processing to step S504, and in the case where it is determined that the luminance value of the determination target pixel does not exceed the upper luminance limit for the overlap, it moves the processing to step S507.

In step S504, the tone limiting unit 205 changes the luminance value of the determination target pixel to the upper luminance limit for the overlap. In other words, the tone limiting unit 205 changes the luminance value of the determination target pixel such that when the projected images are overlapped on the projection plane, the brightness of a pixel corresponding to the determination target pixel is less than or equal to the brightness corresponding to the upper luminance limit. Therefore, with the liquid crystal projector 100 of the present embodiment, an upper luminance limit for the overlap is set in accordance with a luminance adjustment coefficient for each projected image, that is, in accordance with the contribution of the projected image to the brightness of the pixel to adjust the luminance value, as a result of which projected images can be adjusted so as to have brightness in the range similar to that of a non-overlapping region.

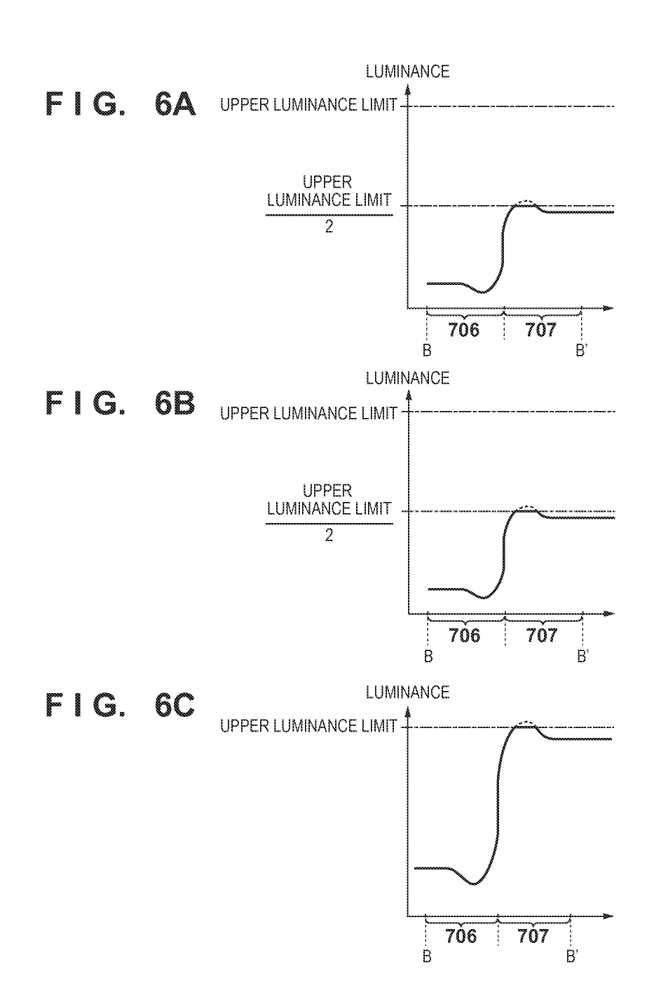

More specifically, regarding a pixel row defined by B-B′ in an overlapping region where two projected images overlap each other in FIG. 7, the luminance value is changed in a manner as shown in FIGS. 6A to 6C. For example, it is assumed that at the position of a pixel defined by B-B′, a luminance adjustment coefficient applied to the projected image 701 on the upper side is 0.5, and a luminance adjustment coefficient applied to the projected image 702 on the lower side also is 0.5. In other words, an upper luminance limit for the overlap set for a partial image corresponding to each projected image is half the upper luminance limit. At this time, as shown in FIGS. 6A and 6B, in each partial image after edge adjustment, a luminance value that exceeds the upper luminance limit for the overlap is changed to the upper luminance limit for the overlap. As a result, even if the projected images after the change overlap each other, it is possible that the brightness does not exceed the brightness corresponding to the upper luminance limit, as shown in FIG. 6C.

Meanwhile, in the case where it is determined in step S502 that the determination target pixel is a pixel in the non-overlapping region, in step S505, the tone limiting unit 205 determines whether or not the luminance value of the determination target pixel exceeds the upper luminance limit. In the case where it is determined that the luminance value of the determination target pixel exceeds the upper luminance limit, the tone limiting unit 205 moves the processing to step S506, and in the case where it is determined that the luminance value of the determination target pixel does not exceed the upper luminance limit, it moves the processing to step S507.

In step S506, the tone limiting unit 205 changes the luminance value of the determination target pixel to the upper luminance limit.

In step S507, the tone limiting unit 205 determines whether or not there is a pixel of the partial image on which the determination has not yet been performed. In the case where there is a pixel on which the determination is not performed, the tone limiting unit 205 returns the processing to S501, and in the case where there are no pixels on which the determination is not performed, the tone limiting unit 205 ends this luminance value change process.

After subjecting the partial image to the luminance value change process in this manner, the CPU 101 performs projection of the partial image in step S406, and ends this projection process. Specifically, the CPU 101 controls the optical system control unit 113 and the liquid crystal control unit 107, and projects an image to be projected corresponding to the partial image that has undergone the image processes, on the projection plane.

Through this, when an image to be projected is projected using a plurality of projected images, a step created due to the edge emphasizing process is eliminated between the overlapping region where projected images are overlapped and the non-overlapping region, and it is possible to perform edge blending at uniform brightness.

Note that although the description was given, assuming that image processes are performed in a projection apparatus such as the liquid crystal projector 100 in the present embodiment, the present embodiment is not necessarily implemented in the projection apparatus, as described above. It will be easily conceivable that the present invention may be implemented in, for example, an image processing apparatus such as a PC or the like that generates partial images of an image to be projected, which are projected by a plurality of projection apparatuses.

As described above, when images projected by a plurality of projection apparatuses are overlapped so as to form one image, the image processing apparatus of the present embodiment is capable of making it difficult for the overlapping region to be noticeable. Specifically, the image processing apparatus performs the luminance adjustment process on partial images in accordance with a predetermined luminance adjustment coefficient, with regard to a region corresponding to the overlapping region where projected images overlap one another at the time of projection. Furthermore, the image processing apparatus performs the edge emphasizing process on the partial images that have undergone the luminance adjustment process. The image processing apparatus then changes the luminance value of a pixel that exceeds an upper luminance limit to the upper luminance limit, in regions of the partial images corresponding to the non-overlapping regions where the projected images do not overlap at the time of projection. In the regions corresponding to the overlapping regions of the partial images, the image processing apparatus changes the luminance value of a pixel that exceeds an upper luminance limit for the overlap, which is smaller than the upper luminance limit, determined in accordance with a luminance adjustment coefficient, to the upper luminance limit for the overlap.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-241100, filed Oct. 31, 2012, which is hereby incorporated by reference herein in its entirety.

What is claimed is:

1. A projection system including a first projector and a second projector,
the first projector comprising:
a first obtainment unit configured to obtain an image to be projected;
a first image processing unit configured to process the image obtained by the first obtainment unit; and
a first projection unit configured to project the image processed by the first image processing unit on a projection plane,
the second projector comprising:
a second obtainment unit configured to obtain an image to be projected;
a second image processing unit configured to process the image obtained by the second obtainment unit; and
a second projection unit configured to project the image processed by the second image processing unit on the projection plane,
wherein in a case where the image projected by the first projection unit and the image projected by the second projection unit are superimposed on the projection plane in the projection system,
(i) the first image processing unit, after a luminance reduction process for reducing the luminance of an image in a portion to be superimposed of the image obtained by the first obtainment unit, performs an edge emphasizing process for emphasizing an edge of the image that has undergone the luminance reduction process, and performs a luminance limiting process for limiting the luminance of the portion to be superimposed of the image that has undergone the edge emphasizing process;
(ii) the second image processing unit, after a luminance reduction process for reducing the luminance of an image in a portion to be superimposed of the image obtained by the second obtainment unit, performs an edge emphasizing process for emphasizing an edge of the image that has undergone the luminance reduction process, and performs a luminance limiting process for limiting the luminance of the portion to be superimposed of the image that has undergone the edge emphasizing process.

2. The projection system according to claim 1, wherein the edge emphasizing process is a process for increasing a difference in luminance between neighboring pixels.

3. The projection system according to claim 1, wherein the first image processing unit, before the edge emphasizing process, performs a transformation process on the image that has undergone the luminance reduction process.

4. The projection system according to claim 3, wherein the first image processing unit, before the edge emphasizing process, performs a process for smoothing a high frequency component of the image that has undergone the transformation process.

5. A projector comprising:
an obtainment unit configured to obtain an image;
an image processing unit configured to process the image obtained by the obtainment unit; and
a projection unit configured to project the image processed by the image processing unit on a projection plane,
wherein the image processing unit, after a luminance reduction process for reducing the luminance of an image in a predetermined region in the image obtained by the obtainment unit, performs an edge emphasizing process for emphasizing an edge of the image that has undergone the luminance reduction process, and performs a luminance limiting process for limiting the luminance of the image in the predetermined region in the image that has undergone the edge emphasizing process.

6. The projector according to claim 5, wherein the edge emphasizing process is a process for increasing a difference in luminance between neighboring pixels.

7. The projector according to claim 5, wherein the image processing unit, before the edge emphasizing process, performs a transformation process on the image that has undergone the luminance reduction process.

8. The projector according to claim 7, wherein the image processing unit, before the edge emphasizing process, performs a process for smoothing a high frequency component of the image that has undergone the transformation process.

9. A control method for a projector,
the projector comprising:
an obtainment unit configured to obtain an image;
an image processing unit configured to process the image obtained by the obtainment unit; and
a projection unit configured to project the image processed by the image processing unit on a projection plane,
wherein the control method controls the image processing unit so as to perform, after a luminance reduction process for reducing the luminance of an image in a predetermined region in the image obtained by the obtainment unit, an edge emphasizing process for emphasizing an edge of the image that has undergone the luminance reduction process, and a luminance limiting process for limiting the luminance of the image in the predetermined region in the image that has undergone the edge emphasizing process.
